(19) United States
(12) Patent Application Publication
(10) Pub. No.: US 2024/0364168 A1
(43) Pub. Date: Oct. 31, 2024

(54) MOTOR

(71) Applicant: LG INNOTEK CO., LTD., Seoul (KR)

(72) Inventors: Jin Su PYEON, Seoul (KR); Kwon Cheol SHIN, Seoul (KR)

(21) Appl. No.: 18/682,700

(22) PCT Filed: Aug. 5, 2022
(86) PCT No.: PCT/KR2022/011688

§ 371 Date: Feb. 9, 2024

(30) Foreign Application Priority Data
Aug. 9, 2021 (KR) 10-2021-0104574

(51) Int. Cl. H02K 3/34; H02K 1/14

(52) U.S. Cl. CPC H02K 3/34; H02K 1/146; H02K 2201/03

(57) ABSTRACT

The present invention may provide a motor including a shaft, a rotor coupled to the shaft, wherein the rotor includes a rotor core and a plurality of magnets coupled to the rotor core, and a stator disposed to correspond to the rotor, wherein the stator includes a stator core, an insulator coupled to the stator core, and a coil disposed on the insulator. In this case, based on an axial direction, the plurality of magnets are disposed at the same position in a circumferential direction, the stator core includes a yoke and a tooth protruding from the yoke, the tooth includes a first region and a second region formed by dividing an inner surface of the tooth facing the rotor in the axial direction, the first region corresponds to a partial region of the inner surface in which a first notch and a second notch are disposed to be spaced apart from each other in the circumferential direction, the second region corresponds to a partial region of the inner surface in which the first notch and the second notch are not present, and an axial length of the second region is in a range of 17% to 35% of an axial length of the stator core.

### TECHNICAL FIELD

The present invention relates to a motor.

### BACKGROUND ART

A motor includes a stator and a rotor.

The stator may include teeth forming a plurality of slots, and the rotor may include a plurality of magnets facing the teeth. Adjacent teeth are disposed to be spaced apart from each other to form slot openings. In this case, while the rotor rotates, a cogging torque may be generated due to a difference in permeability between the stator formed of a metal material and air in the slot openings which are empty spaces. Since the cogging torque causes noise and vibrations, reduction of the cogging torque is very important to improve the quality of the motor.

### DISCLOSURE

### Technical Problem

Accordingly, the present invention is directed to providing a motor of which a cogging torque is reduced.

Objectives to be solved by the present invention are not limited to the above-described objectives, and other objectives which are not described above will be clearly understood by those skilled in the art from the following description.

### Technical Solution

One aspect of the present invention provides a motor including a shaft, a rotor coupled to the shaft, wherein the rotor includes a rotor core and a plurality of magnets coupled to the rotor core, and a stator disposed to correspond to the rotor, wherein the stator includes a stator core, an insulator coupled to the stator core, and a coil disposed on the insulator. In this case, based on an axial direction, the plurality of magnets are disposed at the same position in a circumferential direction, the stator core includes a yoke and a tooth protruding from the yoke, the tooth includes a first region and a second region formed by dividing an inner surface of the tooth facing the rotor in the axial direction, the first region corresponds to a partial region of the inner surface in which a first notch and a second notch are disposed to be spaced apart from each other in the circumferential direction, the second region corresponds to a partial region of the inner surface in which the first notch and the second notch are not present, and an axial length of the second region is in a range of 17% to 35% of an axial length of the stator core.

### Advantageous Effects

According to an embodiment, there is an advantage of significantly reducing a cogging torque by adjusting an axial length of a second region, in which a first notch and a second notch are not present, in an inner surface of a tooth in which the first notch and the second notch are disposed.

According to an embodiment, there is an advantage of significantly reducing a cogging torque in a state in which there is no skew in a rotor.

According to an embodiment, even in a state in which a cogging torque is significantly reduced, a torque increases rather than decreases, and thus there is an advantage of sufficiently securing an output of a motor.

### DESCRIPTION OF DRAWINGS

FIG. 1 is a view illustrating a motor according to an embodiment.

FIG. 2 is a plan view illustrating a stator and a rotor.

FIG. 3 is a perspective view illustrating a stator core.

FIG. 4 is a view illustrating first notches and second notches disposed in teeth of the stator core.

FIG. 5 is a front view illustrating an inner surface of the tooth of the stator core in a radial direction.

FIG. 6 is a view illustrating a modified example of the first notch and a modified example of the second notch.

FIG. 7 is a view illustrating another modified example of the first notch and another modified example of the second notch.

FIG. 8 is a graph showing changes in cogging torque corresponding to second axial lengths.

FIG. 9 is a graph showing cogging torques corresponding to rotation angles in a motor of Comparative Example.

FIG. 10 is a graph showing cogging torques corresponding to rotation angles in the motor of Example.

FIG. 11 is a graph showing changes in cogging torque corresponding to second axial lengths.

FIG. 12 is a graph showing changes in torque corresponding to second axial lengths (L3).

### MODES OF THE INVENTION

A direction parallel to a longitudinal direction (vertical direction) of a shaft is referred to as an axial direction, a direction perpendicular to the axial direction of the shaft is referred to as a radial direction, and a direction along a circle having a radius in the radial direction from the shaft is referred to as a circumferential direction.

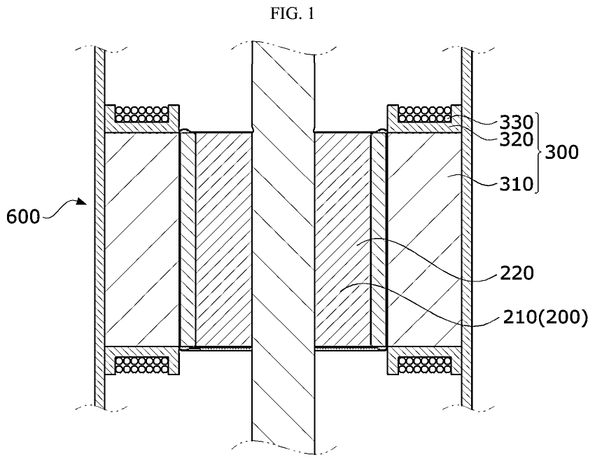

FIG. 1 is a view illustrating a motor according to an embodiment.

Referring to FIG. 1, the motor according to the embodiment may include a shaft 100, a rotor 200, and a stator 300. Hereinafter, the term “inward” is a direction from a housing 600 toward the shaft 100 which is a center of the motor, and the term “outward” is a direction opposite to “inward” that is a direction from the shaft 100 toward the housing 600. In addition, a radial direction is defined based on an axial center of the shaft 100.

The shaft 100 may be coupled to the rotor 200. When an electromagnetic interaction occurs between the rotor 200 and the stator 300 by supplying a current, the rotor 200 rotates, and the shaft 100 rotates in conjunction with the rotation of the rotor 200. The shaft 100 may be a hollow member. A shaft of an external device may be inserted into the shaft 100.

The rotor 200 rotates due to an electrical interaction with the stator 300. The rotor 200 may be disposed inside the stator 300.

The stator 300 is disposed outside the rotor 200. The stator 300 may include a stator core 310, an insulator 320 mounted on the stator core 310, and a coil 330. The coil 330 may be wound around the insulator 320. The insulator 320 is disposed between the coil 330 and the stator core 310 and serves to electrically insulate the stator core 310 from the coil 330. The coil 330 induces an electrical interaction with a magnet of the rotor 200.

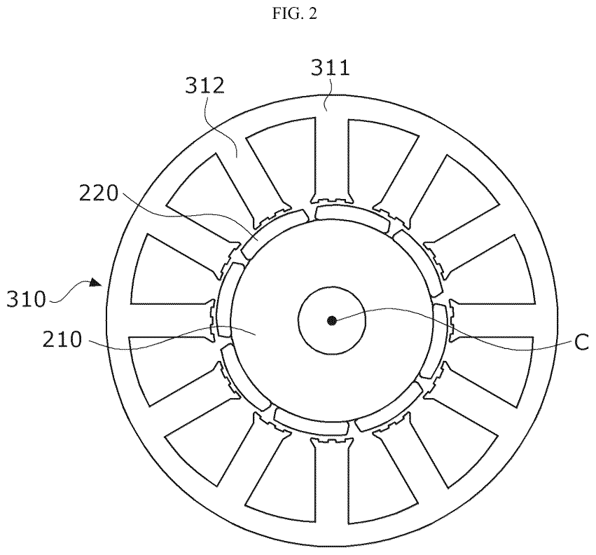

FIG. 2 is a plan view illustrating the stator and the rotor.

Referring to FIG. 2, the stator core 310 may include a yoke 311 and a tooth 312. The tooth 312 may protrude from an inner circumferential surface of the yoke 311 toward a center C of the stator 300. The tooth 312 may be provided as a plurality of teeth 312. The number of teeth 312 may be variously changed to correspond to the number of magnets 220. The stator core 310 may be formed in combination of a plurality of divided cores each including the yoke 311 and the tooth 312.

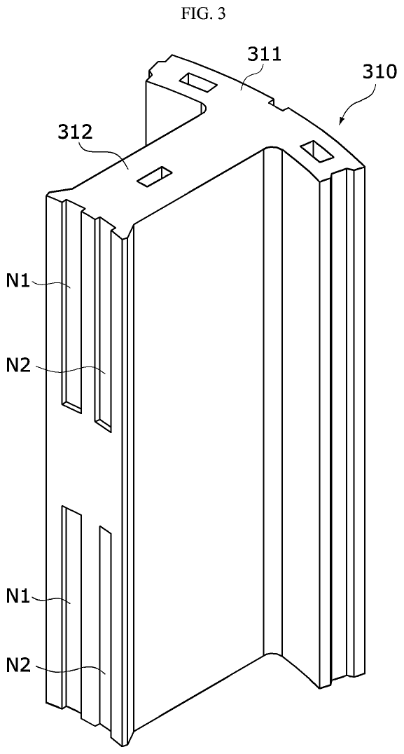

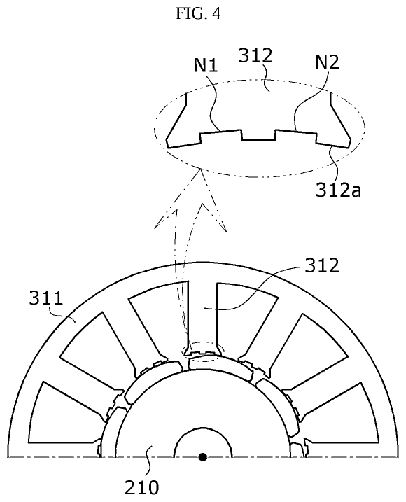

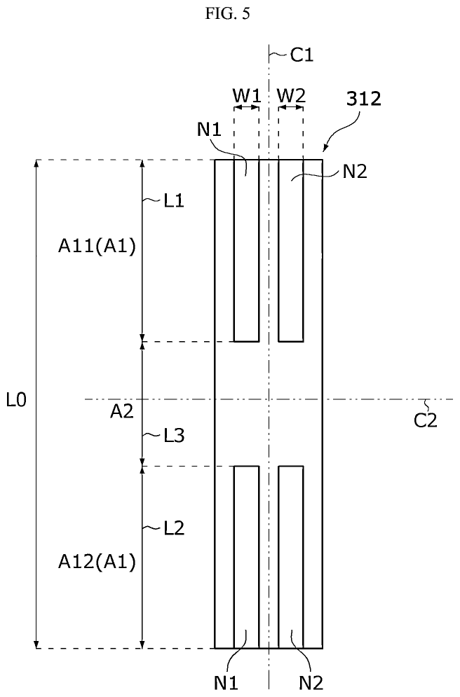

FIG. 3 is a perspective view illustrating the stator core 310, FIG. 4 is a view illustrating first notches N1 and second notches N2 disposed in the teeth 312 of the stator core 310, and FIG. 5 is a front view illustrating an inner surface 312a of the tooth 312 of the stator core 310 in the radial direction.

Referring to FIGS. 3 to 5, the tooth 312 of the stator core 310 may include first regions A1 and a second region A2 formed by dividing the inner surface 312a facing the rotor 200 in the axial direction. The first regions A1 are defined as partial regions of the inner surface 312a of the tooth 312 in which the first notches N1 and the second notches N2 are disposed. The second region A2 is defined as a partial region of the inner surface 312a of the tooth 312 in which the first notches N1 and the second notches N2 are not disposed.

The first notches N1 and the second notches N2 may be concavely formed in the inner surface 312a. In addition, the first notch N1 and the second notch N2 may be disposed to be spaced apart from each other in the circumferential direction.

When the stator 300 is viewed in the radial direction, the first notch N1 and the second notch N2 may be symmetrically disposed with respect to a reference line C1 formed along a center of the tooth 312 in the circumferential direction. Axial lengths L1 and L2 of each of the first notch N1 and the second notch N2 may be the same.

The first regions A1 may include a 1-1 region A11 and a 1-2 region A12 which are spaced apart from each other in the axial direction. The second region A2 is disposed between the 1-1 region A11 and the 1-2 region A12 in the axial direction.

The first notch N1 disposed in the 1-1 region A11 may be formed to extend from one end of the 1-1 region A11 in the axial direction toward the second region A2 in the axial direction. The first notch N1 disposed in the 1-2 region A12 may be formed to extend from one end of the 1-2 region A12 in the axial direction toward the second region A2 in the axial direction.

The second notch N2 disposed in the 1-2 region A12 may be formed to extend from one end of the 1-2 region A12 in the axial direction toward the second region A2 in the axial direction. The second notch N2 disposed in the 1-2 region A12 in the axial direction may be formed to extend from one end of the 1-2 region A12 toward the second region A2 in the axial direction.

When the stator 300 is viewed in the radial direction, based on a reference line C2 formed along a center of the tooth 312 in the axial direction, the 1-1 region A11 may be disposed at one side of the reference line C2, and the 1-2 region A12 may be disposed at the other side of the reference line C2. The 1-1 region A11 and the 1-2 region A12 may be symmetrically disposed with respect to the reference line C2.

The axial length L1 of the 1-1 region A11 and the axial length L2 of the 1-2 region A12 may be the same.

The sum of the axial length L1 of the 1-1 region A11, the axial length L2 of the 1-2 region A12, and an axial length L3 of the second region A2 may correspond to an axial length LO of the stator core 310.

A circumferential length W1 of the first notch N1 may be constant in the axial direction. In addition, a circumferential length W2 of the second notch N2 may be constant in the axial direction. The circumferential length W1 of the first notch N1 and the circumferential length W2 of the second notch N2 may be the same.

Each of the circumferential length W1 of the first notch N1 and the circumferential length W2 of the second notch N2 may be in the range of 11% to 12% of a circumferential length of the tooth 312. For example, when a circumferential width of the tooth 312 is 8.7 mm, each of the circumferential length W1 of the first notch N1 and the circumferential length W2 of the second notch N2 may be 1.0 mm.

As described above, an example in which a shape of the first notch N1 and a shape of the second notch N2 are the same has been described, but the present invention is not limited thereto, and the shape of the first notch N1 and the shape of the second notch N2 may be different.

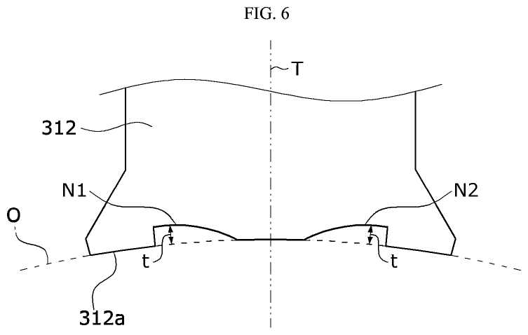

FIG. 6 is a view illustrating a modified example of the first notch N1 and a modified example of the second notch N2.

Hereinafter, a depth t is a value indicating a concave extent in a radial direction from a reference surface O formed along an inner surface of a tooth 312.

Referring to FIG. 6, the first notch N1 and the second notch N2 may be formed in different shapes. For example, based on a reference line T, a depth t of the first notch N1 may increase toward one side in a circumferential direction, and a depth t of the second notch N2 may increase toward the other side in the circumferential direction.

For example, based on the virtual reference line T passing through a center of the tooth 312 and a center of a stator 300 in the circumferential direction, when the first notch N1 is disposed at one side of the reference line T and the second notch N1 is disposed at the other side of the reference line T, each of the first notch N1 and the second notch N2 may be formed so that the depth t increases away from the reference line T in the circumferential direction. Meanwhile, a maximum value of the depth t of the first notch N1 and a maximum value of the depth t of the second notch N2 may be the same.

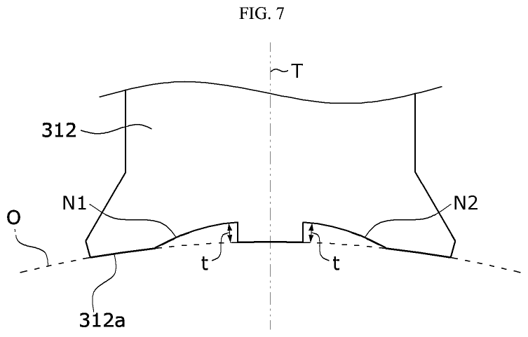

FIG. 7 is a view illustrating another modified example of a first notch N1 and another modified example of the second notch N2.

Referring to FIG. 7, based on a reference line T passing through a center of a tooth 312 and a center of a stator 300 in a circumferential direction, each of the first notch N1 and the second notch N2 may be formed so that a depth t increases toward the reference line T in the circumferential direction. Meanwhile, a maximum value of the depth t of the first notch N1 and a maximum value of the depth t of the second notch N2 may be the same.

A cogging torque may be changed according to an axial length L3 of a second region A2, which is a section in which there is no notch. The axial length L3 of the second region A2 may be in the range of 17% to 35% of an axial length of a stator core 310.

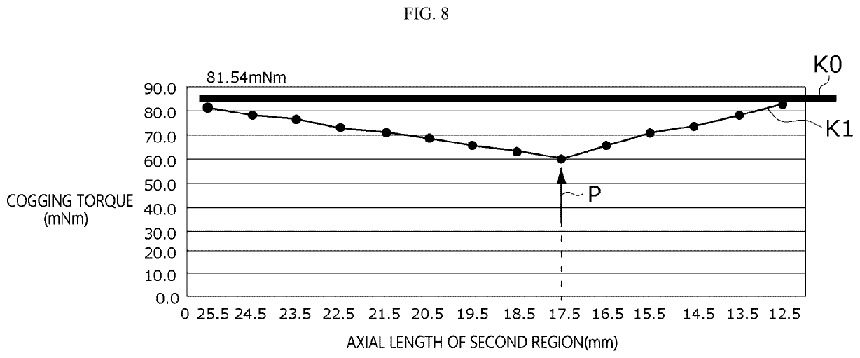

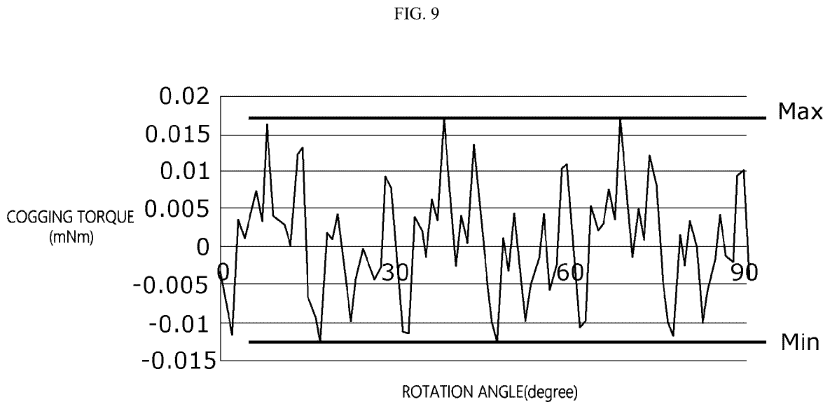

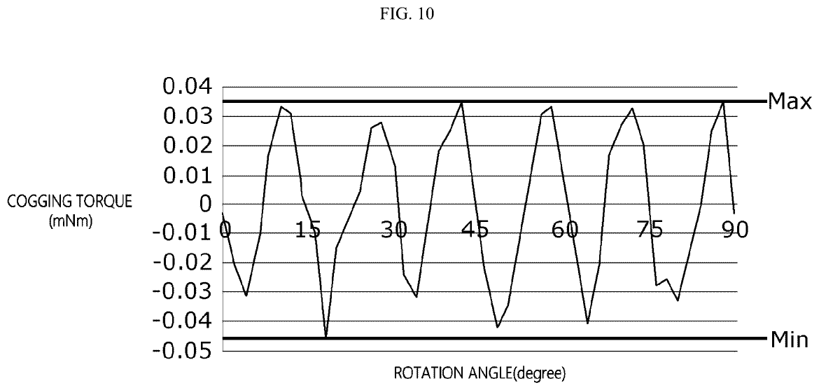

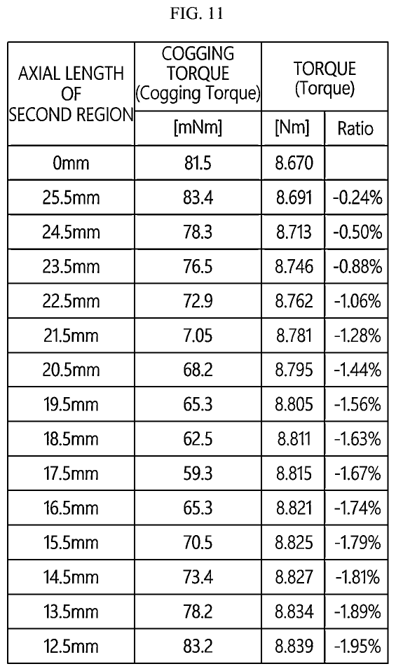

FIG. 8 is a graph showing changes in cogging torque corresponding to second axial lengths L3, and FIG. 9 is a graph showing cogging torques corresponding to rotation angles in a motor of Comparative Example. FIG. 10 is a graph showing cogging torques corresponding to rotation angles in the motor of Example, and FIG. 11 is a graph showing changes in cogging torque corresponding to second axial lengths.

Referring to FIGS. 5, 8, and 11, in the motor of Comparative Example, when an axial length L0 of a stator core 310 is 73.5 mm, a measured cogging torque K0 may be, for example, 81.54 mNm. In this case, Comparative Example corresponds to the motor in a state in which there is no notch in an inner surface 312a of a tooth 312 and there is no skew in magnets 220 of a rotor 200.

In the motor of Example, under a condition of no skew by arranging the magnets 220 at the same position in the circumferential direction, when the axial length L0 of the stator core 310 is 73.5 mm, in a case in which the axial length L3 of the second region A2 is in the range of 17% to 35% of the axial length L0 of the stator core 310, it can be seen that a measured cogging torque K1 of the motor of Example is smaller than the measured cogging torque K0 of the motor of the Comparative Example.

Referring to FIGS. 9 and 10, it can be seen that a maximum value Max of the cogging torque corresponding to the rotation angle of the motor of Example is smaller than that of the motor of Comparative Example. In addition, it can be seen that a minimum value Min of the cogging torque corresponding to the rotation angle of the motor of Example is smaller than that of the motor of Comparative Example. As a result, it can be seen that a change in amplitude of the cogging torque corresponding to the rotation angle of the motor of Example is smaller than that of the motor of Comparative Example.

Referring to FIGS. 8 and 11, in the case of the motor of Example, when the axial length L0 of the stator core 310 is 73.5 mm, the axial lengths L1 and L2 of the first regions A1 are 56 mm, and when the axial length L3 of the second region A2 is 17.5 mm, that is, when the axial length L3 of the second region A2, in which there is no notch, is 24% of the axial length L0 of the stator core 310, it is seen that the cogging torque is the lowest as 59.3 mNm shown as P in FIG. 9.

In a section in which the axial length L3 of the second region A2 is in the range of 17% to 35% of the axial length L0 of the stator core 310, the cogging torque of the motor of Example is generally smaller than that of the motor of Comparative Example.

It can be seen that the cogging torque decreases as the axial length L3 of the second region A2 goes from 35% to 24% of the axial length L0 of the stator core 310 and the cogging torque increases as the axial length L3 of the second region A2 goes from 24% to 17% of the axial length L0 of the stator core 310.

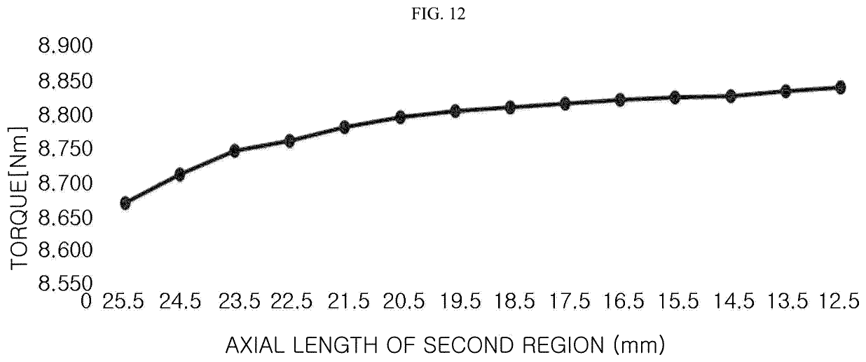

FIG. 12 is a graph showing changes in torque corresponding to the second axial lengths L3.

Referring to FIGS. 11 and 12, since a torque of Example is generally greater than a torque (8.67 Nm) of Comparative Example in a section in which the axial length L3 of the second region A2 is in the range of 17% to 35% of the axial length L0 of the stator core 310, it can be seen that an output of the motor is sufficiently secured while reducing the cogging torque.

The present invention can be used for various devices such as vehicles or home appliances.

1. A motor comprising:
a shaft;
a rotor coupled to the shaft, wherein the rotor includes a rotor core and a plurality of magnets coupled to the rotor core; and
a stator disposed to correspond to the rotor, wherein the stator includes a stator core, an insulator coupled to the stator core, and a coil disposed on the insulator,
wherein the stator core includes a yoke and a tooth protruding from the yoke,
wherein the tooth includes a first region and a second region formed by dividing an inner surface of the tooth facing the rotor in the axial direction,
wherein the first region corresponds to a partial region of the inner surface in which a first notch and a second notch are disposed to be spaced apart from each other in the circumferential direction,
wherein the second region corresponds to a partial region of the inner surface in which the first notch and the second notch are not present, and
wherein an axial length of the second region is in a range of 17% to 35% of an axial length of the stator core.

2. The motor of claim 1, wherein:
the first region includes a 1-1 region and a 1-2 region spaced apart from each other in the axial direction; and
the second region is disposed between the 1-1 region and the 1-2 region in the axial direction.

3. The motor of claim 2, wherein an axial length of the 1-1 region and an axial length of the 1-2 region are the same.

4. The motor of claim 1, wherein a shape of the first notch and a shape of the second notch are different.

5. The motor of claim 4, wherein:
a depth of the first notch increases toward one of two sides in the circumferential direction; and
a depth of the second notch increases toward the other side in the circumferential direction.

6. The motor of claim 5, wherein, based on a reference line passing through a center of the tooth and a center of the stator in the circumferential direction, the depth of each of the first notch and the second notch increases away from the reference line in the circumferential direction.

7. The motor of claim 5, wherein, based on a reference line passing through a center of the tooth and a center of the stator in the circumferential direction, the depth of each of the first notch and the second notch increases toward the reference line in the circumferential direction.

8. The motor of claim 1, wherein the axial length of the stator core is the same as a sum of an axial length of the first region and the axial length of the second region.

9. The motor of claim 1, wherein, based on a reference line passing through a center of the tooth and a center of the stator in the circumferential direction:
the first notch is disposed at one side of the reference line in the circumferential direction;
the second notch is disposed at the other side of the reference line in the circumferential direction;
a circumferential length of the first notch and a circumferential length of the second notch are the same; and
an axial length of the first notch and the axial length of the second notch are the same.

10. The motor of claim 9, wherein the circumferential length of the first notch is in a range of 11% to 12% of a circumferential length of an inner surface of the tooth.
